(19) United States
(12) Patent Application Publication
(10) Pub. No.: US 2009/0268734 A1
(43) Pub. Date: Oct. 29, 2009

(54) EFFICIENT ADDRESS-SPACE EXTENSION TO PSEUDO MULTI-HOMED HOSTS

(75) Inventors: Xiangyu Wang, Eindhoven (NL); Jurjen Henri Eisink, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/813,442

(22) PCT Filed: Jan. 5, 2006
(86) PCT No.: PCT/IB06/50046

§ 371 Date: Jul. 6, 2007

Related U.S. Application Data
(60) Provisional application No. 60/642,962, filed on Jan. 11, 2005.

(51) Int. Cl. H04L 12/56

(52) U.S. Cl. 370/392

(57) ABSTRACT

A residential gateway (130) interfaces in-home hosts (140) to the public Internet without performing address or port translation. Each in-home host is allocated a public address (212) of the gateway and optionally one or more ports (220). The in-home host generates a lower-level version of the gateway IP address for outgoing packets (S370). The gateway maintains a lookup table (720) for public-to-private IP address conversion for packets incoming from the Internet, and finds the lower-level counterpart of the IP address (730). Packets to go out or packets that have arrived are encapsulated without any address or port translation being performed.

The present invention relates to preventing exhaustion of Internet addresses and, in particular, to relieving the network address translation burden on gateways from the public Internet to private networks.

The 32-bit address space for Internet addresses, providing merely 2³² unique addresses, will soon be too small to accommodate the growing number of devices online.

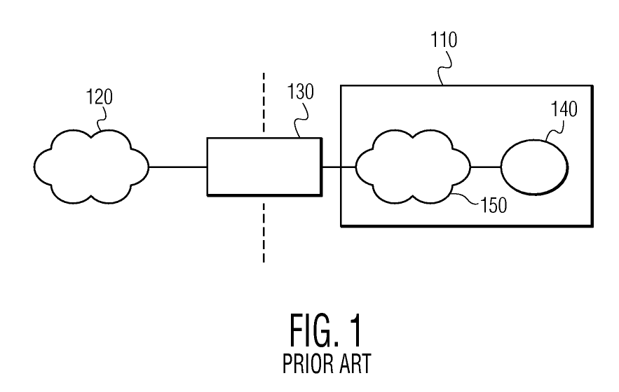

Network address translation (“NAT”) is a proposed technique for extending the life of the 32-bit address space. Referring to FIG. 1, a subnetwork or “subnet” 110 of devices, such as the entirety of home appliances in a home network, may interface with Internet 120 by means of a router or other residential gateway (RG) 130. A host device 140 or “host,” in communicating with the Internet 120, typically encounters other hosts comprising the homenet 150 in reaching the residential gateway 130. The devices or “hosts” 140 on the subnet or “private network” have respective addresses different in format from those on the Internet 120 or “public network.” Thus, the private network 110 is a different address realm than the public network 120. The RG 130 performs NAT to route packets from the private 110 to public network 120, and, if reverse traffic is implemented, from the public to the private network. The RG 130 has a private address for communicating with other hosts 140 on the subnet 110, and public addresses for interfacing with public or “external” hosts in the public address realm 120. These public addresses are allocated to private hosts to afford them external communication.

Network address port translation (“NAPT”) extends the NAT concept. A public address may be shared by private hosts 140 in the subnet 110, each host being allocated one or more respective port numbers. The RG 130 bears the burden of address and port translation.

Disadvantageously, NAT/NATP interferes with a routing principle of the Internet that recommends not modifying packets enroute between source and destination devices. Among other problems, this leads to excessive computation on the residential gateway, causing a bottleneck.

In addition, application-specific ALGs (Application Layer Gateways) have to be implemented so as to allow protocols, such as File Transfer Protocol (FTP) and Session Initiation Protocol (SIP), to traverse the RG 130. Such protocols typically embed Internet Protocol (IP) addresses and port numbers in message payloads rather than in message headers. Consequently, the IP addresses and port numbers do not undergo NAT/NAPT. When new application protocols are invented and to be used, existing as well as new RGs 130 have to be upgraded to accommodate correspondingly new ALGs. This is cumbersome, even if feasible.

As a further drawback, remote access to the in-home network behind NAT/NAPT is not possible unless static mapping is manually created beforehand. The mapping is a binding on the NAT/NAPT between the private address and port of an in-home host 140 to the public address and port for the in-home host at the RG 130. Such manual configuration is subject to error and is not suitable for in-home networks with a lot of consumer electronics (CE) devices 140.

There exists a need to simplify the design of the residential gateway, and to reduce its processing burden. In addition, address and port translation should be made more flexible.

The present invention addresses above-noted shortcomings in the prior art.

In one aspect of the present invention, a group of one or more devices in a first network, that group including a first device, is configured for routing information to a second network, the first and second networks being different address realms. The group derives from an Internet Protocol (IP) address an address of a lower level and creates a packet specifying as a destination a second device within the second network. The group also determines, based on the destination, an address of the second network for the first device and provides the determined address as a source in the packet. The group encapsulates the packet so as to thereby add the derived address. The encapsulated packet is then forwarded to a gateway for routing to the second network.

In another aspect of the present invention, a gateway receives, from a second network, the first and second networks being different address realms, a packet that specifies the location of a device within the first network. The device has an address of a lower level than an Internet address. The gateway, without modifying the received packet as to any address within the received packet, generates, from the received packet, an address of the first network corresponding to the location. The gateway, optionally in combination with one or more devices of the first network, performs acts that include, without the above-described modification of the received packet: a) deriving the lower-level address from the generated address; b) encapsulating the received packet, which adds the derived lower-level address; and c) transmitting the encapsulated packet to the specified location.

In a further aspect of the present invention, a device for preparing, on a first network, a packet for communication, determines whether a destination address is within the first network. If it is determined that the address is not within the first network, the device provides the packet with a source address that is one of the addresses from a second network used by a gateway connecting the first and second networks. If, on the other hand, it is determined that the address is within the first network, the device provides the packet with a source address within the first network.

Details of the invention disclosed herein shall be described with the aid of the figures listed below, wherein:

FIG. 1 is an overview of the interface between the public Internet and a private subnetwork;

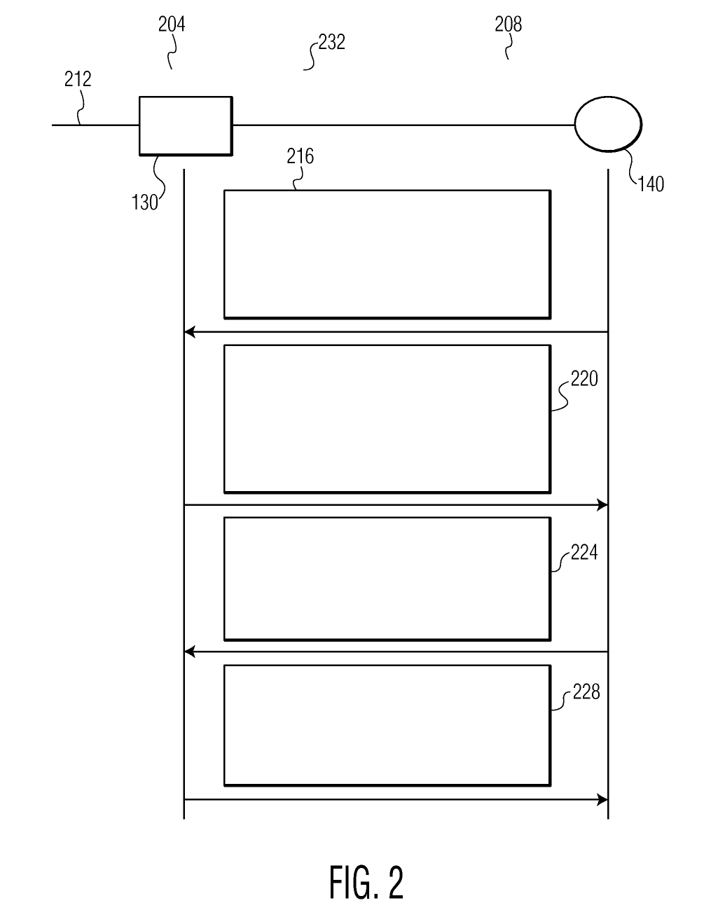

FIG. 2 is a flow diagram representative of one possible protocol for establishing communication between a host behind a residential gateway and the public realm, according to the present invention;

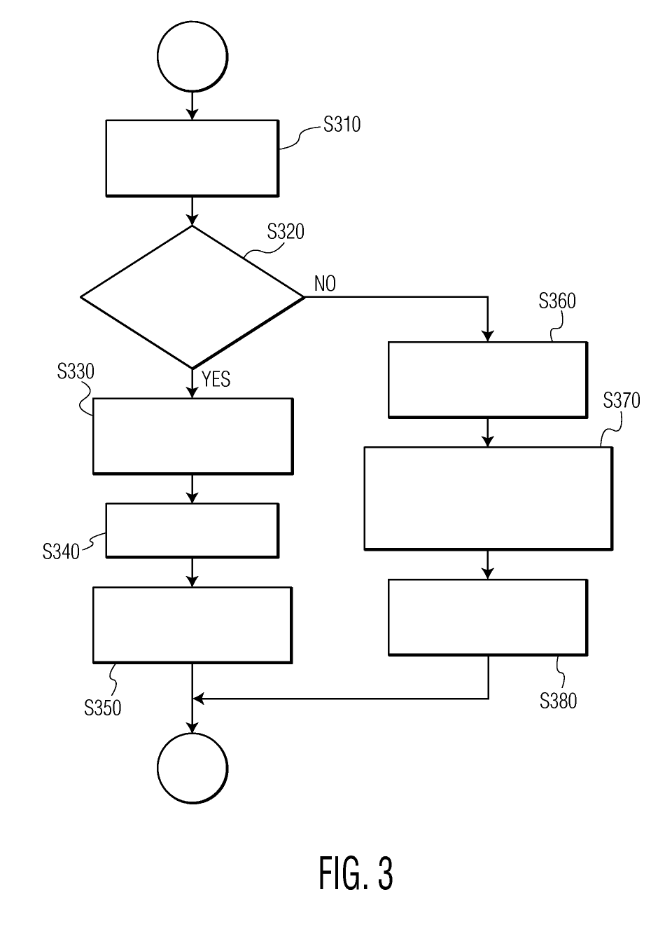

FIG. 3 is flow chart of an exemplary procedure by which a host behind the residential gateway outputs a packet according to the present invention;

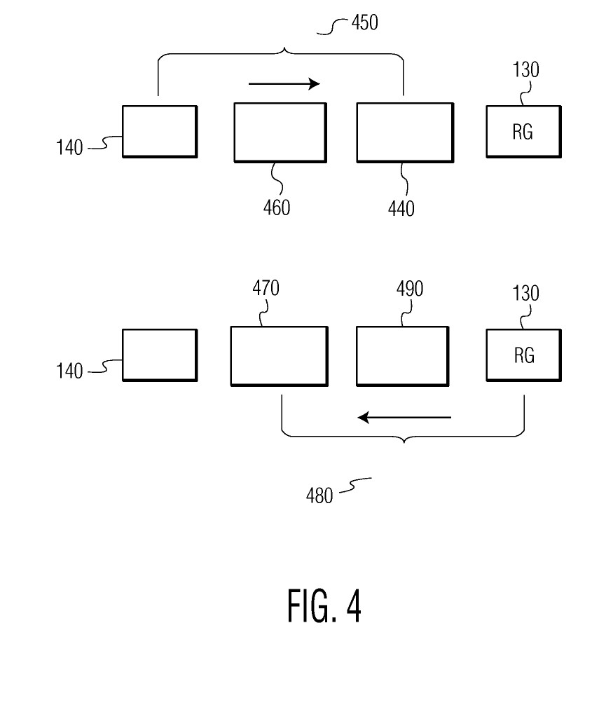

FIG. 4 is a flow diagram illustrating packet flow and functionality grouping of devices in accordance with the present invention;

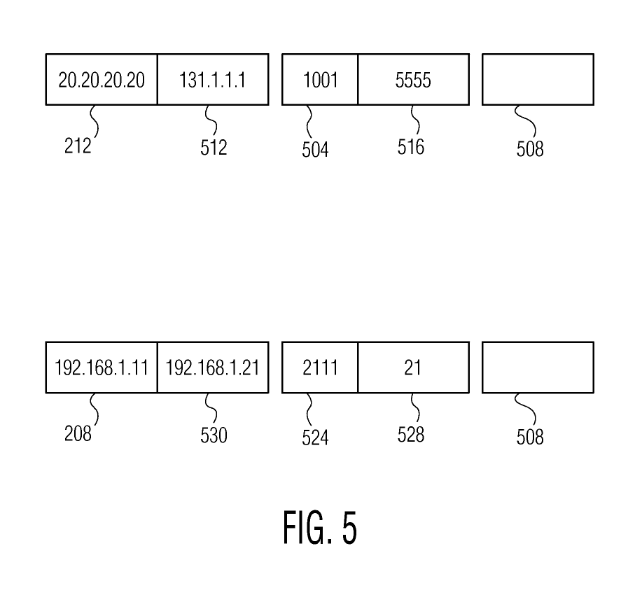

FIG. 5 is a format diagram of packets sent according to the procedure in FIG. 3;

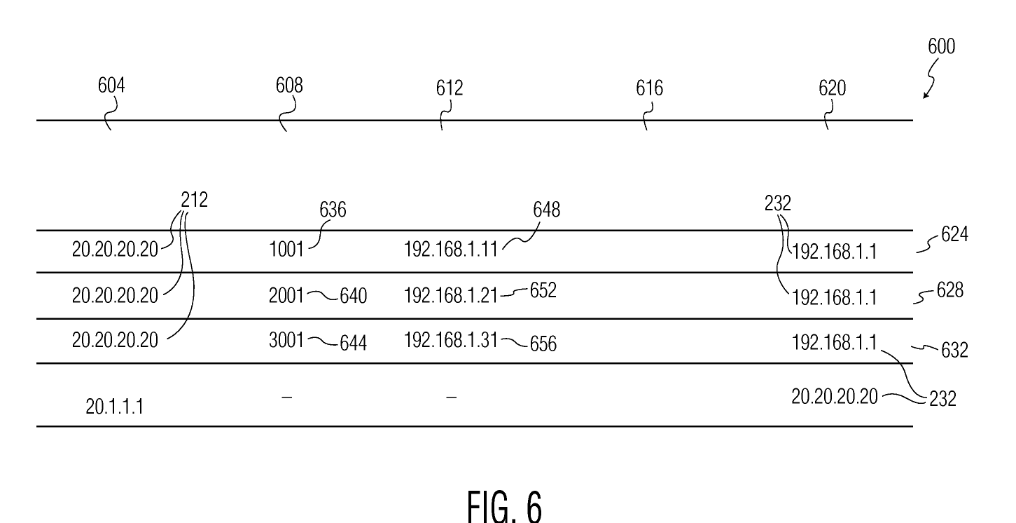

FIG. 6 is an example of an internal table used by a residential gateway in accordance with the present invention; and

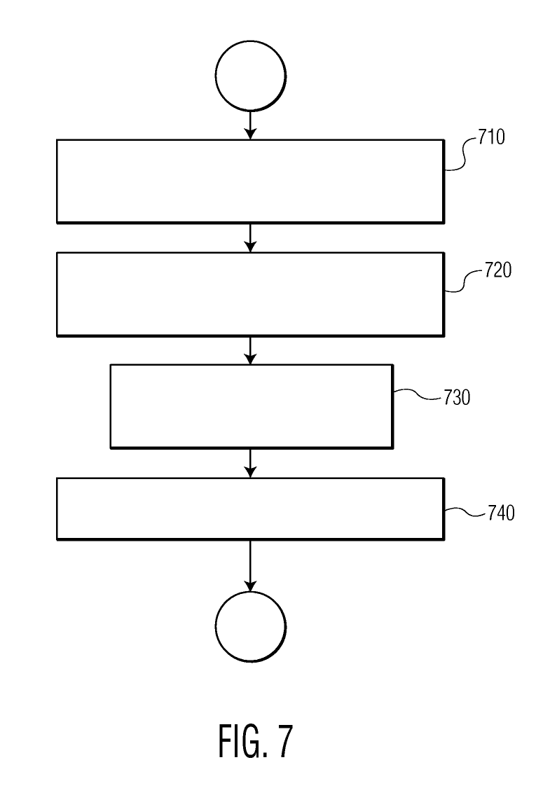

FIG. 7 is a flow chart of an exemplary process by which the residential gateway processes packets incoming from the public address realm.

FIG. 2 shows, by way of illustrative and non-limitative example, a protocol used in affording the host 140 behind the RG 130 access to and from the public realm 120, according to the present invention.

When an in-home host 140 boots up, it normally uses DHCP to obtain an IP address for its network interface from a DHCP server 204 located on the RG 130. Since the in-home network 110 is a private network, the DHCP server 204 allocates to the in-home host, or “DHCP client” 140, a private address 208 (e.g., 192.168.1.11). This allocation occurs as a result of a request by the DHCP client 140 to the DHCP server 204 and a reply by the server.

In accordance with the present invention, the DHCP client 140 can, in addition, be allocated a public address 212 and optionally one or more ports. DHCP provides an option called “vendor specific information” by which the DHCP request and reply messages may be enhanced as tailored by the user. After this option has been implemented, the in-home host 140 can obtain a public address 212, which may be one of a number of public addresses for the RG 130. The in-home host 140 can also obtain a range of ports associated with the public address 212.

As shown in FIG. 2, a first DHCP request message 216 and its reply message 220 have the conventional, respective first components, numbered ‘1,” by which the in-home host 140 gets a private address. The second components, numbered “2,” are implemented as part of the option, and relate to the public address 212 and ports 3000 to 3010 for differentiating communications through the public address.

Once an in-home host 140 gets a certain port or port range, it can make use of that port or those ports together with the public address in subsequent communications.

The private addresses 208 allocated under DHCP are leased for a predetermined, renewable period of time, and the public addresses allocated according to the present invention may likewise be leased on a renewable basis. This process is demonstrated by request message 224 and reply message 228 in FIG. 2.

In addition to the address (and port) configuration, the in-home hosts 140 would also be configured with at least one router address, which is typically the internal address 232 of the RG, here “198.168.1.1.” One way of getting this address is by use of the DHCP “default router” option.

The fact that the in-home host 140 owns two IP addresses from two different subnets implies that the host is a multi-homed host. However, since the in-home host 140 has only one network interface, it is not a true “multi-homed” host, and is herein termed a “pseudo multi-homed host.”

The private address and the public address are both bound to the network interface. This is already possible on Linux. As an example, using the following commands will achieve the same result. “ifconfig eth0 192.168.1.11” configures the Ethernet interface 0 with the private address of 192.168.1.11. “ifconfig eth0:1 20.20.20.20” configures the same interface with the public address 20.20.20.20.

The in-home host 140 treats the private address as just a conventional IP address that is configured on the network interface. More specifically, the in-home host 140 responds to Address Resolution Protocol (ARP) requests on the mapping between the private address and the Media Access Control (MAC) address or “physical address” of the network interface. The physical address is considered to be an address of a lower level than an IP address. Two other designations for the physical address are “hardware address” and “Ethernet address.” The device driver at the data link layer does not understand Internet addresses, i.e., in the format xxx.xxx.xxx.xxx, but instead needs the physical address. ARP is a mechanism by which to translate the Internet address to its physical address counterpart. If, for the example, the RG 130 receives from the public network 120 a packet for an in-home host 140, the RG will use ARP to translate the Internet address to the physical address. If the physical address has not been retained in the RG's cache from a previous ARP invocation, the RG dispatches a packet with the Internet address. The appropriate host 140 recognizes the Internet address and responds with its physical address. According to the present invention, the Internet address sent to that host 140 is its private address. The public address is not involved in ARP, since this address is owned by the RG.

FIG. 3 shows an exemplary method by which the in-home host 140 prepares an outgoing packet according to the present invention. Whenever data to be transmitted from the in-home host 140 is received from the application layer (step S310) that sits on top of the TCP/IP layer, a query is made as to whether the destination address of the peer device is on the same subnet (step S320). The response to this query can be provided by executing a small Linux program known as “netmask” that executes a comparison between elements of the respective addresses.

When the answer is “Yes,” the host 140 follows conventional steps to send the packet. First, the host 140 uses the private address as the source IP address in the packet header (step S330). Then, the host 140 determines the MAC address for the peer by invoking ARP procedures. In a relatively simple network, which is assumed in this example, the packet is to arrive at the peer in a single hop.

However, more generally, an intermediate router, for instance, may receive the packet enroute. It would then typically be the last enroute device 440, referring to FIG. 4, that performs ARP for the address of the peer who is the recipient indicated by the destination address in step S320 (step S340). In other words, a device one hop away from the peer, in wrapping or “encapsulating” the packet for transmission to the peer, inserts the address derived through ARP into the packet. Assuming again the simple case, that device is the host 140, which encapsulates in a MAC header the IP packet containing the payload message, and sends the encapsulated packet to the peer (step S350).

When the answer is “No,” the source address field in the IP header is filled with the public IP address of the host 140 (step S360). This differs from the conventional situation, where the host would use its private address as the source if it is communicating with the router by means of the router's private address.

As mentioned above, the host 140 has been provided, upon configuration, with the private IP address of the RG 130. Accordingly, the host 140 determines the respective physical address by ARP. This can involve one of two steps. If this particular physical address has already been calculated and remains in the host's ARP cache, the physical address is derived by merely copying from the cache. On the other hand, if the particular physical address is not available from the cache, the host broadcasts an ARP request. RG 130 recognizes its own IP address, which may be one of many belonging to the RG, and responds to the host 140 with an ARP reply after inserting in the packet its physical hardware address. The host can therefore derive the physical hardware address to be inserted into or added to the packet at this time by the appropriate one of the two methods (step S370). Next, the host 140 wraps the IP packet in a MAC header. The source address is the physical address of the network interface of the host 140. The destination address is the determined physical address of the RG 130. The host 130 sends the encapsulated packet to the RG 130 (step S380).

Although, in the above example, communication is between a private network 110 and a public network 120, the intended scope of the invention is between one address realm and another address realm.

Also the above example assumes a relatively simple subnet wherein the host 140 is transmitting the packet directly to the RG 130. On a larger network, however, and as mentioned above, transmission may be through, for example, an intermediate router. In the general sense, a group 450 of one or more devices that includes the host 140 may be involved in delivering the packet to the RG 130. The group may include, for example, a device 440, other than the host 140, that is one hop away from the RG 130. Thus, for instance, in the case of communication outside the subnet 110, the group: determines, based on the destination (step S320), the address to be specified as a source address of the packet (step S360); derives, from the IP address of the RG 130, a lower-level address; adds the derived address in encapsulating the packet; and forwards the encapsulated packet to the RG for routing outside the subnet. If the group consists merely of the host 140, the host performs all of these functions. If, for example, the group also includes the device 440 a hop away from the RG 130, functionality may be divided so that the host 140 creates the packet, determines the ultimate destination address, and provides this address as a source address in the packet, whereas the device 440 derives the lower-level address of the RG, adds this address in encapsulating the packet and forwards the encapsulated packet to the RG. One or more other devices 460 in the subnet 110, such as other intermediate nodes or routers, may exist along the path of the packet from the host 140 to the device 440 a hop away from the RG 130.

FIG. 5 provides an exemplary format for packets sent by the procedure in FIG. 3. As an example of a packet to be issued in communicating with a host on the Internet 120, assume first that the in-home host 140 has been allocated, by means of the DHCP processing in FIG. 2, a port “1001” 504 associated with its allocated public address “20.20.20.20” 211 . The host 140 wishes to send a message 508 to it peer on the public Internet 120 having an address 512 of “131.1.1.1” and a port “5555” 511. The port numbers 504, 516 appear in the Transport Control Protocol (TCP) or User Datagram Protocol (UDP) header of the packet encapsulating the payload message 508. The IP (Internet Protocol) header, includes the IP source and destination addresses 212, 512.

When the peer is on the same subnet as the in-home host 140, the source address 208 in the IP header is the private address. The destination address 520 of the in-home peer is, in the present example, “192.168.1.21.” The source and destination ports 524, 528 are “2111” and “21” respectively.

Packets incoming at the RG 130 from the Internet 120 are not necessarily routed merely based on IP layer information, i.e., IP addresses, as is conventional, but also optionally based upon transport layer information, specifically the ports in the TCP/UDP header. Therefore, multiple in-home hosts 140 can be multiplexed onto a single public address.

FIG. 6 is one example of a routing table 600 for the RG 130, according to the present invention. The mapping from destination address 604 and destination port 608 to destination address in Private Address Realm 612 in the routing table 600 can be established and updated by a DHCP message exchange similar to that in FIG. 2.

The exemplary table 600 has the following columns: destination address 604, destination port 608, destination address in private address realm 612, forwarding interface 616 and interface IP address 620. The first three rows 624, 628, 632 correspond respectively to three hosts 140. Notably, each uses the same RG-owned public private address 232 and public address 212, but is distinguished at the interface by respective ports 536, 540, 544. In addition, the three hosts 140 have respective addresses 548, 552, 556 within the subnetwork 110. The forwarding interface 616 is an Ethernet interface connecting to the private network, and the fourth row 620 is the private address for the forwarding interface.

FIG. 7 shows an example of how a packet received from the Internet 120 at the RG 130 is processed. In step 710, the arriving packet has a destination address 212 of “20.20.20.20” which is the public address of the RG 130. The destination port 540 is “2001.” In step 720, before consuming the packet by an application on the RG 130, lookup on the routing table 600 finds, based on the destination port 540, the destination address 552 of the corresponding in-home host, namely “192.168.1.21.” Different from conventional router processing, which would invoke ARP on “20.20.20.20”, i.e., the destination address of the packet, the RG 130 invokes ARP to resolve the looked-up private address “192.168.1.21” (step 730). In step 740, after deriving the MAC address for the destination host 140, the router 130 wraps the original, incoming IP packet with a MAC header and sends the encapsulated packet to the destination host specified in the received packet.

Analogous to the situation noted above with respect to outgoing packets, incoming packets in a more complex network may likewise be internally routed through an intermediate router, for example, which may or may not be a hop away from the destination host 140. Referring back to FIG. 4, a device 470 a hop away from the host 140 will encapsulate with the derived address. In the general case, the RG 130 operates, optionally in combination with one or more devices in the subnetwork 110, i.e., as part of a “gateway group 480,” in receiving the packet from outside the subnet 110, generating the address of the first network for the destination host specified in the received packet, deriving the MAC address, encapsulating the received packet so as to thereby add the derived MAC address, and transmitting the packet, thus encapsulated, to the destination host. As in the analogous situation in outputting a packet, the packet incoming to the subnet 110 may follow a path from the RG 130 to the device 470 that traverses one or more intermediate nodes 490.

For outgoing packets from the in-home hosts 140 to the Internet 120, the RG 130 is no different than the normal router, which makes routing decisions on the destination IP addresses found in the packets even when the source IP address 212 appears to be one of the IP addresses that the RG owns on its public interface.

While there have been shown and described what are considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A group (450) of one or more devices in a first network (110), said group including a first device (140), said group for routing information to a second network (S360), the first and second networks being different address realms, said group being configured for deriving from an Internet Protocol (IP) address an address of a lower level (S370) and for creating a packet specifying as a destination a second device within said second network, said group being further configured for determining (S320), based on the destination, an address of said second network for the first device and for providing the determined address as a source in said packet (S360), said group being also configured for encapsulating said packet so as to thereby add the derived address and form an encapsulated packet, and for forwarding the encapsulated packet to a gateway (130) for routing to said second network (S380).

2. The group of claim 1, wherein said group contains merely said first device (S380).

3. The group of claim 1, wherein said group contains, in addition to said first device, a device a hop away from said gateway (440).

4. The group of claim 3, wherein said first device performs said creating, determining and providing (S320, S360), said device a hop away performing the deriving, adding, encapsulating, forming and forwarding (S370, S380).

5. The group of claim 4, wherein said group contains merely said first device and the device a hop away from said gateway (110, 130).

6. The group of claim 3, wherein said first network includes a device along a path followed by said packet from said first device to said gateway (460).

7. A system including said group and said gateway of claim 1, wherein said gateway (130) is configured for, without modifying the forwarded packet as to any address within the forwarded packet, stripping off encapsulation (212, 512) to leave the created packet (504, 508, 516) and transmitting the left packet to said destination.

8. The group of claim 1, further configured for said encapsulating without modifying the created packet as to any address within the created packet (212, 512).

9. The group of claim 1, wherein said deriving entails a device of said group receiving the lower-level address upon request by said device of said group (S370).

10. The group of claim 1, wherein said IP address is an address of the first (232) or second (212) network for said gateway.

11. The group of claim 1, wherein Dynamic Host Configuration Protocol (DHCP) provides said IP address to said first device (220).

12. The group of claim 1, wherein the derived address is a physical address (S370).

13. The group of claim 1, wherein said first network is a private network and said second network is a public network (220).

14. The group of claim 1, further configured for creating a packet specifying as a destination a third device within said first network, said first device being further configured for determining (S320), based on the destination, an address of said first network for said first device and for using the determined address of said first network as a source in said packet (S330).

15. The group of claim 1, further configured for specifying as a source in the created packet a port (216) associated with said determined address.

16. A gateway group (480) consisting of a gateway (130) and optionally one or more devices of a first network (110), said group configured for receiving, from a second network, the first and second networks being different address realms, a packet that specifies a location of a device within said first network (710), said device having an address of a lower level than an Internet address (730) and, without modifying the received packet as to any address within the received packet, generating, from the received packet, an address of the first network corresponding to said location, said gateway group performing acts comprising, without said modifying: a) deriving the lower-level address from the generated address; b) encapsulating said received packet so as to thereby add the derived lower-level address and form an encapsulated packet; and c) transmitting said encapsulated packet to the specified location (710-740).

17. The gateway group of claim 16, wherein the specifying by the received packet is based upon a port number contained within the received packet, said gateway being further configured to read the port number (504) from said received packet, said generating being based on the read port number.

18. A method for preparing, on a first network, a packet for communication, comprising the steps of:
determining whether a destination address is within the first network (S320);
if it is determined that the address is not within the first network, providing the packet with a source address that is one of addresses from a second network used by a gateway connecting the first and second networks (S360); and
if it is determined that the address is within the first network, providing the packet with a source address within the first network (S330).

19. The method of claim 18, further comprising the step of defining a Dynamic Host Configuration Protocol (DHCP) option for allocating to a DHCP client of a DHCP server on the gateway an address of said second network for the gateway (216, 220), said determining and the performing based on the determination being performed by said client (140).

20. The method of claim 19, wherein said option allocates in response to a request message from the client (216).

21. The method of claim 20, further comprising the step of sending, by the client, said request message to the DHCP server (204) and allocating, by the DHCP server to the client, said address of said second network (220).

22. The method of claim 19, further comprising the step of defining a DHCP option for allocating, to the client, one or more ports of the second network in response to a message from the client requesting said one or more ports (216, 220).

23. The method of claim 22, further comprising the step of defining a DHCP option for renewing a lease on said one or more ports in response to a message from the client requesting said renewal (224, 228).

24. The method of claim 19, further comprising the step of defining a DHCP option for renewing a lease on the allocated address in response to a message from the client requesting said renewal (224, 228).

25. A device for preparing, on a first network, a packet for communication, said device being configured for:
determining whether a destination address is within the first network (S320);
if it is determined that the address is not within the first network, providing the packet with a source address that is one of addresses from a second network used by a gateway connecting the first and second networks (S360); and
if it is determined that the address is within the first network, providing the packet with a source address within the first network (S330).

26. A method for routing information, the method comprising the steps of:
receiving, in a first network from a second network, the first and second networks being different address realms, a packet that specifies a location of a device within said first network (710), said device having an address of lower level than an Internet address; and,
without modifying the received packet as to any address within the received packet:
generating, from the received packet, an address corresponding to said location (720);
deriving the lower-level address from the generated address (730);
encapsulating the received packet so as to thereby add the derived lower-level address and form an encapsulated packet; and
transmitting said encapsulated packet to the specified location (740).

27. The method of claim 26, wherein said lower-level address is a physical address (730).

28. A method for routing information from a first network to a second network, the first and second networks being different address realms, the method comprising the steps of:
deriving from an Internet Protocol (IP) address an address of lower level (S370);
creating, by a first device in said first network, a packet specifying as a destination a second device within said second network (504, 516);
without modifying the created packet as to any address within the created packet, encapsulating said created packet so as to thereby add the derived address and form an encapsulated packet;
forwarding the encapsulated packet to another device in the first network (S380); and
without modifying the forwarded packet as to any address within the forwarded packet, stripping off the encapsulation to leave the created packet and transmitting the left packet to said destination.

29. The method of claim 28, wherein said transmitting comprises the step of, first, re-encapsulating said created packet for transmission (S380).

30. The method of claim 28, wherein said address of lower level is a physical address (S370).

31. The method of claim 28, wherein said first device (140) belongs to a group (450) of one or more devices in said first network and said deriving entails a device of said group receiving the lower level address upon request by said device of said group (S370).

32. The method of claim 28, wherein said IP address is an address of the first (232) or second (212) network for a gateway (130) that performs said stripping and transmitting.

33. The method of claim 28, further comprising providing (220), by Dynamic Host Configuration Protocol (DHCP), said IP address to said first device.
